(19) United States
(12) Patent Application Publication
(10) Pub. No.: US 2024/0268474 A1
(43) Pub. Date: Aug. 15, 2024

(54) AEROSOL GENERATING DEVICE AND OPERATING METHOD THEREOF

(71) Applicant: KT&G CORPORATION, Daejeon (KR)

(72) Inventors: Dong Sung KIM, Seoul (KR); Young Bum KWON, Gyeonggi-do (KR); Yong Hwan KIM, Gyeonggi-do (KR); Hun II LIM, Seoul (KR); Seok Su JANG, Daejeon (KR)

(73) Assignee: KT&G CORPORATION, Daejeon (KR)

(21) Appl. No.: 18/564,933

(22) PCT Filed: Nov. 9, 2022
(86) PCT No.: PCT/KR2022/017506

§ 371 Date: Nov. 28, 2023

(30) Foreign Application Priority Data
Nov. 11, 2021 (KR) 10-2021-0155185
Feb. 16, 2022 (KR) 10-2022-0020208

(51) Int. Cl. A24F 40/51; A24F 40/20; A24F 40/465; A24F 40/485; A24F 40/53

(52) U.S. Cl. CPC A24F 40/51; A24F 40/465; A24F 40/485; A24F 40/53; A24F 40/20

(57) ABSTRACT

An aerosol generating device includes a housing including an opening into which an aerosol generating article is inserted, a heater assembly located inside the housing and including an accommodation space for accommodating an aerosol generating article that is inserted through the opening, an airflow passage located between the housing and the heater assembly to allow an outside of the aerosol generating device to fluid-communicate with an inside of the accommodation space, a sensor arranged adjacent to the airflow passage and configured to detect at least one of a pressure change and a temperature change in the airflow passage, and a processor electrically connected to the sensor and configured to output a notification of a user's puff action, based on the at least one of a pressure change and a temperature change of the airflow passage.

### TECHNICAL FIELD

Embodiments relate to an aerosol generating device that may detect a user's puff action through a pressure change or a temperature change of an airflow passage and an operating method of the aerosol generating device.

### BACKGROUND ART

Recently, the demand for technology replacing a method of supplying aerosols by burning a cigarette in the related art has increased. For example, studies have been conducted on a method of supplying aerosols having flavors by generating aerosols from an aerosol generating material in a liquid state or a solid state or generating a vapor from an aerosol generating material in a liquid state and then passing the vapor through a fragrance medium in a solid state.

Recently, an aerosol generating device that may generate an aerosol by heating an aerosol generating article has been proposed as a way to replace a method of supplying an aerosol by burning a cigarette. For example, the aerosol generating device may refer to a device that may generate an aerosol by heating an aerosol generating material in a liquid or solid state to a preset temperature with a heater.

An aerosol generating device improves a user's smoking convenience, because a user may smoke without an additional accessory such as a lighter, and also may smoke as much as possible. In particular, research on an aerosol generating device capable of detecting a user's puff action has increased.

### DISCLOSURE OF INVENTION

### Technical Problem

In general, aerosol generating devices measure a temperature of an aerosol generating article or a heat source for heating the aerosol generating article and detect a user's puff action based on a temperature change the aerosol generating article or the heat source.

However, in this case, a sensor for detecting a temperature is placed in a high-temperature environment, and thus the sensor is likely to perform an abnormal operation or be damaged by the high temperature, resulting in reduction of detection accuracy of a puff action.

The technical problems to be solved by the embodiments of the disclosure are not limited to the above-described problems, and problems that are not mentioned will be clearly understood by those of ordinary skill in the art from the disclosure and the accompanying drawings.

### Solution to Problem

Various embodiments of the present disclosure provide an aerosol generating device that may detect a user's puff action through a pressure change or a temperature change in an airflow passage separated from an aerosol generating article and a heater, and an operating method thereof. Accordingly, detection accuracy of a puff action is improved.

An aerosol generating device according to an embodiment includes a housing including an opening into which an aerosol generating article is inserted, a heater assembly located inside the housing and including an accommodation space for accommodating an aerosol generating article that is inserted through the opening, an airflow passage located between the housing and the heater assembly to allow an outside of the aerosol generating device to fluid-communicate with an inside of the accommodation space, a sensor arranged adjacent to the airflow passage and configured to detect at least one of a pressure change and a temperature change in the airflow passage, and a processor electrically connected to the sensor and configured to output a notification of a user's puff action, based on a pressure change amount and a temperature change amount of the airflow passage.

An operating method of an aerosol generating device includes detecting, by a sensor, at least one of a pressure change and a temperature change of an airflow passage that is formed between a housing including an opening into which an aerosol generating article is inserted and a heater assembly including an accommodation space for accommodating the aerosol generating article inserted through the opening, the airflow passage allowing an outside of the aerosol generating device to fluid-communicate with the accommodation space, and outputting a notification of a user's puff action based on the at least one a pressure change amount and a temperature change amount of the airflow passage.

### Advantageous Effects of Invention

An aerosol generating device according to various embodiments of the present disclosure may prevent a sensor from performing an abnormal operation or being damaged due to a temperature, thereby improving detection accuracy of a user's puff action.

In addition, an aerosol generating device according to various embodiments of the present disclosure may output a notification indicating that there is occurrence of a user's puff action to improve user convenience.

Technical problems to be solved by the embodiments are not limited to the above-described problems, and problems that are not mentioned will be clearly understood by those of ordinary skill in the art from the disclosure and the accompanying drawings.

### BRIEF DESCRIPTION OF DRAWINGS

FIG. 1 is a perspective view of an aerosol generating device according to an embodiment.

FIG. 2 is a cross-sectional view schematically illustrating components of an aerosol generating device according to an embodiment.

FIG. 3 is an enlarged cross-sectional view of some components of an aerosol generating device according to an embodiment.

FIG. 4 is a view illustrating airflow according to a user's puff action in the aerosol generating device illustrated in FIG. 3.

FIG. 5 is a flowchart illustrating a process of detecting a user's puff action from an aerosol generating device, according to an embodiment.

FIG. 6 is a flowchart illustrating a process of detecting a user's puff action from an aerosol generating device, according to another embodiment.

FIG. 7 is an enlarged cross-sectional view illustrating some components of an aerosol generating device according to another embodiment.

FIG. 8 is a flowchart illustrating a process of detecting a user's puff action from the aerosol generating device illustrated in FIG. 7.

FIG. 9 is a block diagram of an aerosol generating device according to another embodiment.

### MODE FOR THE INVENTION

With respect to the terms used to describe the various embodiments, general terms which are currently and widely used are selected in consideration of functions of structural elements in the various embodiments of the disclosure. However, meanings of the terms can be changed according to intention, a judicial precedence, the appearance of new technology, and the like. In addition, in certain cases, terms which can be arbitrarily selected by the applicant in particular cases. In such a case, the meaning of the terms will be described in detail at the corresponding portion in the description of the present disclosure. Therefore, the terms used in the various embodiments of the disclosure should be defined based on the meanings of the terms and the descriptions provided herein.

In addition, unless explicitly described to the contrary, the word “comprise” and variations such as “comprises” or “comprising” will be understood to imply the inclusion of stated elements but not the exclusion of any other elements. In addition, the terms “-er”, “-or”, and “module” described in the specification mean units for processing at least one function and operation and can be implemented by hardware components or software components and combinations thereof.

As used herein, hen an expression such as “at least any one” precedes arranged elements, it modifies all elements rather than each arranged element. For example, the expression “at least any one of a, b, and c” should be construed to include a, b, c, or a and b, a and c, b and c, or a, b, and c.

In an embodiment, an aerosol generating device may be a device that generates aerosols by electrically heating a cigarette accommodated in an interior space thereof.

The aerosol generating device may include a heater. In an embodiment, the heater may be an electro-resistive heater. For example, the heater may include an electrically conductive track, and the heater may be heated when currents flow through the electrically conductive track.

The heater may include a tube-shaped heating element, a plate-shaped heating element, a needle-shaped heating element, or a rod-shaped heating element, and may heat the inside or outside of a cigarette according to the shape of a heating element.

A cigarette may include a tobacco rod and a filter rod. The tobacco rod may be formed of sheets, strands, and tiny bits cut from a tobacco sheet. Also, the tobacco rod may be surrounded by a heat conductive material. For example, the heat conductive material may be, but is not limited to, a metal foil such as aluminum foil.

The filter rod may include a cellulose acetate filter. The filter rod may include at least one segment. For example, the filter rod may include a first segment configured to cool aerosols, and a second segment configured to filter a certain component in aerosols.

In another embodiment, the aerosol generating device may be a device that generates aerosols by using a cartridge containing an aerosol generating material.

The aerosol generating device may include a cartridge that contains an aerosol generating material, and a main body that supports the cartridge. The cartridge may be detachably coupled to the main body, but is not limited thereto. The cartridge may be integrally formed or assembled with the main body, and may also be fixed to the main body so as not to be detached from the main body by a user. The cartridge may be mounted on the main body while accommodating an aerosol generating material therein. However, the disclosure is not limited thereto. An aerosol generating material may also be injected into the cartridge while the cartridge is coupled to the main body.

The cartridge may contain an aerosol generating material in any one of various states, such as a liquid state, a solid state, a gaseous state, a gel state, or the like. The aerosol generating material may include a liquid composition. For example, the liquid composition may be a liquid including a tobacco-containing material having a volatile tobacco flavor component, or a liquid including a non-tobacco material.

The cartridge may be operated by an electrical signal or a wireless signal transmitted from the main body to perform a function of generating aerosols by converting the phase of an aerosol generating material inside the cartridge into a gaseous phase. The aerosols may refer to a gas in which vaporized particles generated from an aerosol generating material are mixed with air.

In another embodiment, the aerosol generating device may generate aerosols by heating a liquid composition, and the generated aerosols may be delivered to a user through a cigarette. That is, the aerosols generated from the liquid composition may move along an airflow passage of the aerosol generating device, and the airflow passage may be configured to allow aerosols to be delivered to a user by passing through a cigarette.

In another embodiment, the aerosol generating device may be a device that generates aerosols from an aerosol generating material by using an ultrasonic vibration method. At this time, the ultrasonic vibration method may mean a method of generating aerosols by converting an aerosol generating material into aerosols with ultrasonic vibration generated by a vibrator.

The aerosol generating device may include a vibrator, and generate a short-period vibration through the vibrator to convert an aerosol generating material into aerosols. The vibration generated by the vibrator may be ultrasonic vibration, and the frequency band of the ultrasonic vibration may be in a frequency band of about 100 kHz to about 3.5 MHz, but is not limited thereto.

The aerosol generating device may further include a wick that absorbs an aerosol generating material. For example, the wick may be arranged to surround at least one area of the vibrator, or may be arranged to contact at least one area of the vibrator.

As a voltage (for example, an alternating voltage) is applied to the vibrator, heat and/or ultrasonic vibrations may be generated by the vibrator, and the heat and/or ultrasonic vibrations generated by the vibrator may be transmitted to the aerosol generating material absorbed in the wick. The aerosol generating material absorbed in the wick may be converted into a gaseous phase by heat and/or ultrasonic vibrations transmitted from the vibrator, and as a result, aerosols may be generated.

For example, the viscosity of the aerosol generating material absorbed in the wick may be lowered by the heat generated by the vibrator, and as the aerosol generating material having a lowered viscosity is granulated by the ultrasonic vibrations generated from the vibrator, aerosols may be generated, but is not limited thereto.

In another embodiment, the aerosol generating device is a device that generates aerosols by heating an aerosol generating article accommodated in the aerosol generating device in an induction heating method.

The aerosol generating device may include a susceptor and a coil. In an embodiment, the coil may apply a magnetic field to the susceptor. As power is supplied to the coil from the aerosol generating device, a magnetic field may be formed inside the coil. In an embodiment, the susceptor may be a magnetic body that generates heat by an external magnetic field. As the susceptor is positioned inside the coil and a magnetic field is applied to the susceptor, the susceptor generates heat to heat an aerosol generating article. In addition, optionally, the susceptor may be positioned within the aerosol generating article.

In another embodiment, the aerosol generating device may further include a cradle.

The aerosol generating device may configure a system together with a separate cradle. For example, the cradle may charge a battery of the aerosol generating device. Alternatively, the heater may be heated when the cradle and the aerosol generating device are coupled to each other.

Hereinafter, the disclosure will now be described more fully with reference to the accompanying drawings, in which exemplary embodiments of the disclosure are shown such that one of ordinary skill in the art may easily work the disclosure. The disclosure may be implemented in a form that can be implemented in the aerosol generating devices of the various embodiments described above or may be implemented in various different forms, and is not limited to the embodiments described herein.

Hereinafter, embodiments of the disclosure will be described in detail with reference to the drawings.

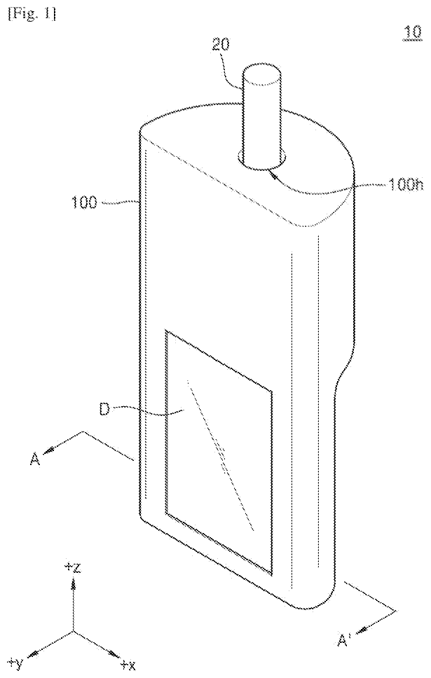

FIG. 1 is a perspective view of an aerosol generating device according to an embodiment;

Referring to FIG. 1, an aerosol generating device 10 according to an embodiment may include a housing 100 into which an aerosol generating article 20 may be inserted.

The housing 100 may form an overall appearance of the aerosol generating device 10 and include an inner space (or ‘arrangement space’) in which components of the aerosol generating device 10 may be arranged. In the drawings, only an embodiment, in which a cross section of the housing 100 is formed in a semicircular shape as a whole, is illustrated, but the shape of the housing 100 is not limited thereto. According to an embodiment (not illustrated), the housing 100 may also be formed in a cylindrical shape or a polygonal pole (for example, a triangular pole or a quadrangular pole) shape as a whole.

Components for generating an aerosol by heating an aerosol generating article 20 inserted into the housing 100 and components for detecting a user's puff action may be arranged in an inner space of the housing 100, and details thereof are described below.

According to one embodiment, the housing 100 may include an opening 100h through which the aerosol generating article 20 may be inserted into the housing 100. At least a part of the aerosol generating article 20 may be inserted into or accommodated in the housing 100 through the opening 100h.

The aerosol generating article 20 inserted or accommodated in the housing 100 may be heated in the housing 100, and thus an aerosol may be generated. The aerosol generated in the housing 100 may be discharged to the outside of the aerosol generating device 10 through the inserted aerosol generating article 20 and/or through a space between the aerosol generating article 20 and the opening 100h, and a user may inhale the discharged aerosol.

The aerosol generating device 10 according to an embodiment may further include a display D on which visual information is displayed.

At least a partial region of the display D may be arranged to be exposed to the outside of the housing 100, and the aerosol generating device 10 may provide various types of visual information to a user through the display D.

For example, the aerosol generating device 10 may provide a user with information on whether there is occurrence of a user's puff action and/or information on a remaining number of puffs of the inserted aerosol generating article 20 through the display D. Information provided through the display D is not limited to the embodiment described above.

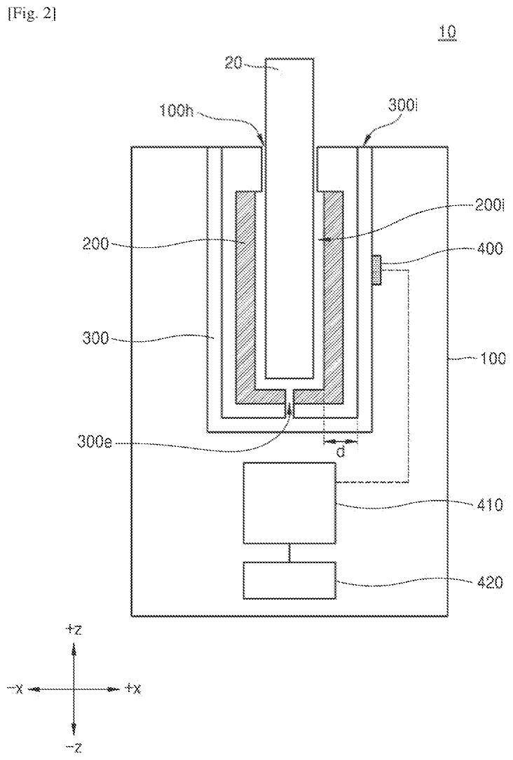

FIG. 2 is a cross-sectional view schematically illustrating components of an aerosol generating device according to an embodiment. FIG. 2 is a cross-sectional view taken in a direction A-A′ of the aerosol generating device illustrated in FIG. 1.

Referring to FIG. 2, the aerosol generating device 10 (for example, the aerosol generating device 10 of FIG. 1) according to an embodiment may include a housing 100 (for example, the housing 100 of FIG. 1), a heater assembly 200, an airflow passage 300, and a sensor 400.

The housing 100 forms an overall appearance of the aerosol generating device 10 and include an inner space in which components of the aerosol generating device 10 may be arranged. For example, the heater assembly 200, the airflow passage 300, and the sensor 400 may be arranged in the inner space of the housing 100, but the inner space is not limited thereto.

According to one embodiment, the housing 100 may include an opening 100h, and at least a part of the aerosol generating article 20 may be inserted into (or accommodated in) the housing 100 through the opening 100h. Although the drawing illustrates an embodiment in which the opening 100h is formed in a region facing the +z direction of the housing 100, an arrangement structure of the opening 100h is not limited to the illustrated embodiment.

The heater assembly 200 may be in the inner space of the housing 100, and an aerosol may be generated by heating the aerosol generating article 20 inserted into the housing 100 through the opening 100h.

According to one embodiment, the heater assembly 200 may include an accommodation space 200i for accommodating at least a part of the aerosol generating article 20 that is inserted into the housing 100 through the opening 100h, and a heater (not illustrated) for generating heat according to power that is supplied. At least one region of the aerosol generating article 20 may be heated by a heater and generate an aerosol as vaporized particles generated by heating of the aerosol generating article 20 are mixed with air introduced into the housing 100 through the opening 100h.

In one embodiment, a heater of the heater assembly 200 may include an induction heating type heater. For example, the heater may include a coil (or an ‘electrically conductive coil’) that generates an alternating magnetic field as power is supplied, and a susceptor that generates heat by the alternating magnetic field generated by the coil. The susceptor may be arranged to surround at least a part of an outer circumferential surface of the aerosol generating article 20 inserted into the housing 100 to heat the inserted aerosol generating article 20.

In another embodiment, the heater of the heater assembly 200 may include an electrically resistive heater. For example, the heater may include a film heater arranged to surround at least a part of an outer circumferential surface of the aerosol generating article 20 inserted into the housing 100. The film heater may include an electrically conductive track, which may generate heat when an electric current flows through the electrically conductive track.

In another embodiment, the heater of the heater assembly 200 may include at least one of a needle-type heater, a rod-type heater, and a tube-type heater that may heat the inside of the aerosol generating article 20 inserted into the housing 100. The above-described heater may be inserted into, for example, at least one region of the aerosol generating article 20 to heat an inside of the aerosol generating article 20.

The heater is not limited to the embodiments described above, and various types of heaters may be used as long as the aerosol generating article 20 may be heated to a designated temperature. In the present disclosure, the ‘designated temperature’ may refer to a temperature at which an aerosol generating material included in the aerosol generating article 20 may be heated to generate an aerosol. The designated temperature may be a preset in the aerosol generating device 10, but the temperature may also change depending on a type of the aerosol generating device 10 and/or an operation of a user.

The airflow passage 300 may be located between the housing 100 and the heater assembly 200 in an inner space of the housing 100 such that the outside of the aerosol generating device 10 is in fluid communication with (or in fluid connection to) the accommodation space 200i of the heater assembly 200.

According to one embodiment, the airflow passage 300 may be separated from the heater assembly 200, and may be arranged to connect an air inlet 300i formed in one region (an example: one region facing the +z direction) of the housing 100 to an air outlet 300e formed in the accommodation space 200i of the heater assembly 200. For example, the airflow passage 300 may be formed in a substantially “U” shape to surround the heater assembly 200 while being separated from the heater assembly 200, but the shape of the airflow passage 300 is not limited to the embodiment described above.

Due to the arrangement structure of the airflow passage 300 described above, the outside of the aerosol generating device 10 may fluid-communicate with the inside of the accommodation space 200i. As a result, air outside (hereinafter, ‘external air’) of the aerosol generating device 10 may flow into the airflow passage 300 through the air inlet 300i, move along the airflow passage 300, and then move into the accommodation space 200i through the air outlet 300e.

According to an embodiment, the airflow passage 300 may be arranged to be separated from the accommodation space 200i of the heater assembly 200 by a designated distance d, and as a result, a temperature and/or pressure of the airflow passage 300 may not be affected by heat generated by the heater of the heater assembly 200. In the present disclosure, the ‘designated distance d’ may refer to a distance at which a temperature and/or pressure of the airflow passage 300 is not affected by heat generated from the heater of the heater assembly 200, and the expression may be used in the same meaning below.

The sensor 400 may be arranged adjacent to the airflow passage 300 separated by a designated distance d from the accommodation space 200i of the heater assembly 200 and may detect a temperature change or a pressure change of the airflow passage 300 according to a user's puff action to detect the user's puff action.

In one embodiment, the sensor 400 may include a pressure sensor that detects a pressure change in the airflow passage 300 according to a user's puff action. In another embodiment, the sensor 400 may include a temperature sensor that detects a temperature change in the airflow passage 300 according to a user's puff action.

In another embodiment, the sensor 400 may include both a pressure sensor and a temperature sensor to detect both a pressure change and a temperature change in the airflow passage 300 according to a user's puff action. Details of this embodiment are described below.

If the heater assembly 200 and the airflow passage 300 are arranged adjacent to each other, a temperature and/or a pressure of the airflow passage 300 may be changed due to heat generated by the heater assembly 200 even in a situation where there is no user's puff action.

Meanwhile, in the aerosol generating device 10 according to an embodiment a temperature and/or a pressure in the airflow passage 300 is not affected by the heater assembly 200 because the airflow passage 300 is separated from the accommodation space 200i of the heater assembly 200 by the designated distance d. As a result, detection accuracy of a puff action is improved.

In general, the sensor 400 of an aerosol generating device, which detects a user's puff action based on a temperature change in the aerosol generating article 20 or the heater assembly 200, is exposed inevitably to a high-temperature environment. In this case, the sensor 400 is likely to perform an abnormal operation or be damaged due to heat.

In the aerosol generating device 10 according to an embodiment, the sensor 400 is arranged adjacent to the airflow passage 300 which is separated from the heater assembly 200. Thus, the sensor 400 may be prevented from abnormally operating or being damaged due to heat generated from the heater assembly 200, and as a result, detection accuracy of detecting the user's puff action may be improved.

The aerosol generating device 10 according to an embodiment may further include a processor 410 and a battery 420.

The processor 410 may control the overall operation of the aerosol generating device 10. In one example, the processor 410 may be electrically or operatively connected to a heater of the heater assembly 200 to control an operation of the heater. In another example, the processor 410 may be electrically or operatively connected to the sensor 400 to detect a user's puff action based on a pressure change or a temperature change of the airflow passage 300 detected by the sensor 400. In the present disclosure, the expression ‘operatively connected’ may indicate a state in which components are connected to transmit and receive signals through wireless communication or to transmit and receive optical signals, magnetic signals, and/or so on, and the expression may be used in the same meaning below.

According to an embodiment, the processor 410 may be arranged or mounted in a printed circuit board (not illustrated) located in an inner space of the housing 100 and may be electrically or operatively connected to a heater and/or the sensor 400 through an electrical connection member (for example, a cable, a C-clip, a FPCB, and so on) that connects a printed circuit board, a heater of the heater assembly 200 and/or the sensor 400. However, the arrangement structure of the processor 410 is not limited to the embodiment described above, and an arrangement structure of the processor 410 may be changed depending on embodiments.

The battery 420 may supply power necessary for an operation of the aerosol generating device 10. For example, the battery 420 may supply power to the heater of the heater assembly 200. In another example, the battery 420 may supply power necessary for an operation of the processor 410 or may also supply power necessary for an operation of the sensor 400.

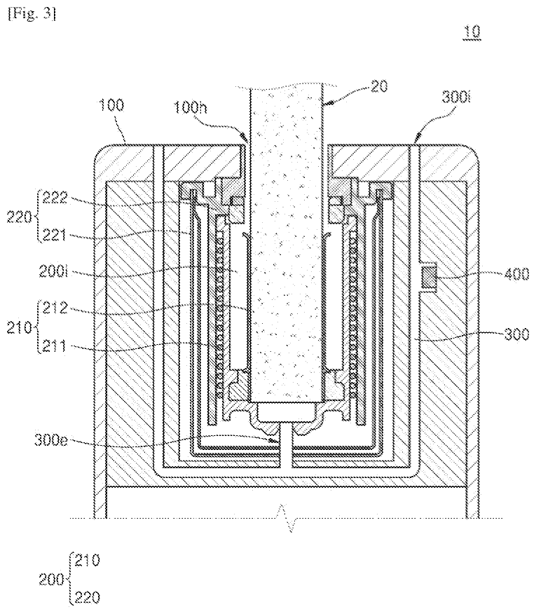

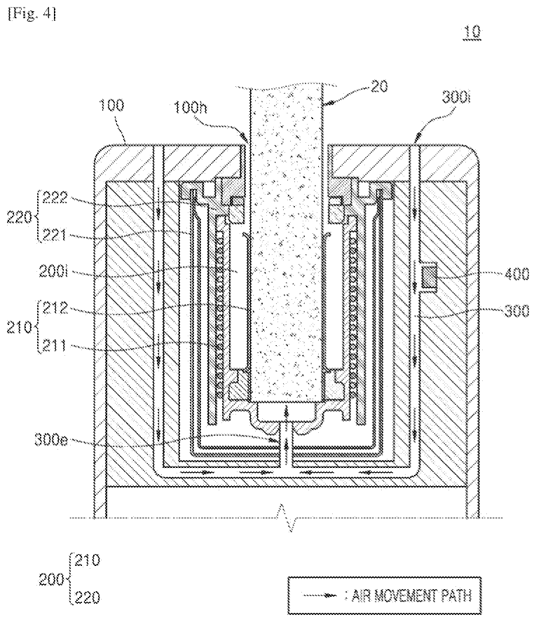

Hereinafter, a detailed configuration of the heater assembly 200 of the aerosol generating device 10 and movement of air according to a user's puff action will be described in detail with reference to FIGS. 3 and 4.

FIG. 3 is an enlarged cross-sectional view of some components of an aerosol generating device according to an embodiment. FIG. 3 is a cross-sectional view specifically illustrating the heater assembly 200 of the aerosol generating device 10 of FIG. 2.

Referring to FIG. 3, an aerosol generating device 10 according to an embodiment may include a housing 100, a heater assembly 200, an airflow passage 300, and a sensor 400. At least one of components of the aerosol generating device 10 according to an embodiment may be the same as or similar to at least one of the components of the aerosol generating device 10 illustrated in FIG. 2, and thus, redundant descriptions thereof are omitted below.

The heater assembly 200 may be located in an inner space of the housing 100 and may include an accommodation space 200i for accommodating an aerosol generating article 20 that is inserted into the inner space of the housing 100 through an opening 100h, and a heater 210 for heating the aerosol generating article 20 accommodated in the inner space 200i.

According to an embodiment, the heater 210 may include a coil 211 and a susceptor 212 to heat at least one region of the aerosol generating article 20 accommodated in the accommodation space 200i in an induction heating manner.

The coil 211 may be arranged to surround an outer circumferential surface of the susceptor 212 and may generate an alternating magnetic field through power supplied from a battery (for example, the battery 420 of FIG. 2).

The susceptor 212 may be arranged to surround at least a part of an outer circumferential surface of the aerosol generating article 20 accommodated in the accommodation space 200i to heat the aerosol generating article 20 accommodated in the accommodation space 200i. For example, the susceptor 212 may heat the aerosol generating article 20 accommodated in the accommodation space 200i by generating heat according to the alternating magnetic field generated by the coil 211.

However, an embodiment of the heater 210 is not limited to the embodiment described above. For example, the heater 210 may also include an electrically resistive heater that may heat the inside and/or outside of the aerosol generating article 20 accommodated in the accommodation space 200i.

According to an embodiment, the heater assembly 200 may further include a heat insulating structure 220 for sealing the heater 210.

The heat insulating structure 220 may be arranged to surround the heater 210 and seal the heater 210 to prevent droplets generated in an aerosol generation process by the heater 210 from being discharged to the outside of the heater assembly 200. Thus, it is possible to prevent components of the aerosol generating device 10 from abnormally operating or being damaged due to the droplets.

In addition, the heat insulating structure 220 seals the heater 210 to prevent the heat generated from the heater 210 from being transmitted to an outer circumferential surface of the housing 100. Thus, it is possible to prevent heat of a high temperature from being transferred from the heater 210 to the body (for example, the palm) of a user holding the housing 100.

According to an embodiment, the heat insulation structure 220 may have a first structure 221 arranged to surround at least one region (for example, a lower region and a side region) of an outer circumferential surface of the heater 210 and a second structure 222 that is located on an upper end of the first structure 221 and covers another region (for example, an upper region) of an outer circumferential surface of the heater 210. The heater 210 may be located in an inner space formed by the first structure 221 and the second structure 222, and the first structure 221 and the second structure 222 may seal the heater 210 located in an inner space.

According to an embodiment, the second structure 222 may be coupled to at least one region of an upper end of the first structure 221 but is not limited thereto. In another embodiment (not illustrated), the first structure 221 and the second structure 222 may be integrally formed.

The airflow passage 300 may be separated from the heater assembly 200 and allow the outside of the aerosol generating device 10 to fluid-communicate with the accommodation space 200i of the heater assembly 200. Thereby, the airflow passage 300 may serve as a flow path for external air to flow into the accommodation space 200i.

According to one embodiment, the airflow passage 300 may be arranged to connect an air inlet 300i formed in one region of the housing 100 to an air outlet 300e formed in the accommodation space 200i of the heater assembly 200. In this case, the air outlet 300e may be formed to penetrate at least one region of the heater assembly 200, and thereby, the inside of the accommodation space 200i may be connected to the airflow passage 300.

External air may be introduced into the accommodation space 200i through the airflow passage 300. The external air introduced into the accommodation space 200i may be mixed with vaporized particles generated as the aerosol generating article 20 is heated by the heater 210, and as a result, an aerosol may be generated.

The sensor 400 may be arranged adjacent to the airflow passage 300 to detect a temperature change or a pressure change in the airflow passage 300. For example, the sensor 400 may be located at a passage that branches off from the airflow passage 300 in a direction away from the heater assembly 200 and may detect the temperature change or the pressure change of the airflow passage 300 according to a user's puff action. However, the arrangement structure of the sensor 400 is not limited to the embodiment described above.

In one example, the sensor 400 may include a pressure sensor to detect a pressure change amount of the airflow passage 300 according to a user s puff action, but is not limited thereto. In another example, the sensor 400 may include a temperature sensor to detect a temperature change amount of the airflow passage 300 according to a users puff action.

Information on the temperature change amount or the pressure change amount of the airflow passage 300 which is detected by the sensor 400 may be transmitted to a processor (for example, the processor 410 of FIG. 2), and the processor may detect whether there is occurrence of the users puff action based on the temperature change amount or the pressure change amount of the airflow passage 300 which is detected by the sensor 400. However, descriptions on a process of detecting the users puff action by using a detection result of the sensor 400 of the processor will be described below.

According to one embodiment, the airflow passage 300 may be arranged to be separated from the accommodation space 200i of the heater assembly 200 by a designated distance (for example, the designated distance d in FIG. 2) such that a temperature and/or a pressure inside the airflow passage 300 does not change due to heat generated by the heater 210.

If the airflow passage 300 and the heater assembly 200 are arranged adjacent to each other, a temperature and/or a pressure of the airflow passage 300 may change due to the heat generated by the heater 210, even when there is no puff action by a user. In this case, even though there is no occurrence of a users puff action, the user's puff action is falsely detected as a temperature change and/or a pressure change in the airflow passage 300 due to the heat generated by the heater 210 is mistaken for a temperature change and/or a pressure change in the airflow passage 300 due to the user's puff action.

In the aerosol generating device 10 according to an embodiment, a temperature and/or a pressure of the airflow passage 300 do not change due to the heat generated by the heater 210, because the airflow passage 300 is separated by a designated distance from the heater assembly 200. As a result, detection accuracy of the user's puff action may be improved.

In addition, the aerosol generating device 10 according to an embodiment may detect a user's puff action based on a temperature change or a pressure change in the airflow passage 300, rather than based on a temperature change of the aerosol generating article 20, thereby stably detecting the user's puff action without being affected by a change in properties or state of the aerosol generating article 20 according to heating.

FIG. 4 is a view illustrating airflow according to a user's puff action in the aerosol generating device illustrated in FIG. 3. An aerosol generating device 10 illustrated in FIG. 4 may be substantially the same as or similar to the aerosol generating device 10 of FIG. 3, and redundant descriptions thereof are omitted below.

Referring to FIG. 4, the aerosol generating device 10 according to an embodiment may detect a pressure change or a temperature change in the airflow passage 300 through the sensor 400 and detect a user's puff action based on the detected pressure change or temperature change in the airflow passage 300.

When a user performs a puff action on the aerosol generating article 20, a pressure difference is generated between the outside of the aerosol generating device 10 and an inner space of the housing 100, causing external air to be introduced into the housing 100 through the air inlet 300i. The external air introduced into the housing 100 may move through the airflow passage 300 and flow into the accommodation space 200i of the heater assembly 200 through the air outlet 300e.

In this case, the external air introduced into the accommodation space 200i may be mixed with vaporized particles, which are generated as the aerosol generating article 20 is heated, to generate an aerosol. A user may inhale the aerosol generated in the accommodation space 200i through a puff action.

The aerosol generating device 10 according to an embodiment may detect, by the sensor 400, a pressure change or a temperature change in the airflow passage 300 which occurs while external air moves through the airflow passage 300 according to a user's puff action and detect whether a user performs a puff action based on the detected the pressure change amount or the temperature change amount of the airflow passage 300.

In addition, when the user's puff action is detected, a processor may output a notification (or ‘user notification’), which indicates that there is occurrence of a puff action, to a user.

For example, the notification may include a visual notification indicating that there is occurrence of a user's puff action through visual information, an audible notification indicating that there is occurrence of the user's puff action through audible information (for example, sound), and a tactile notification indicating that there is occurrence of the user's puff action through tactile information (for example, vibration), but is not limited thereto.

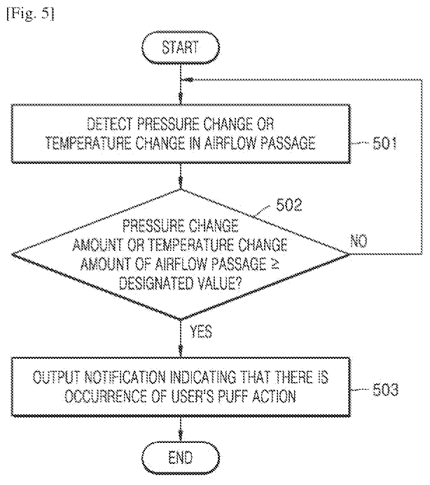

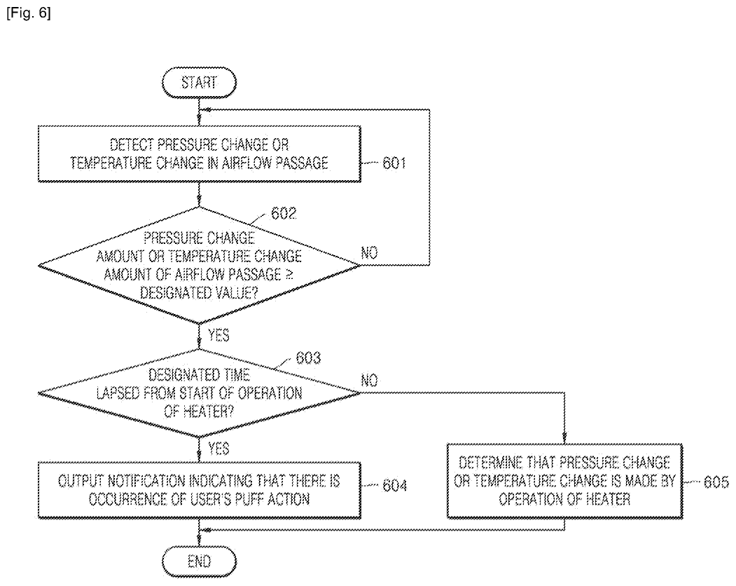

Hereinafter, an operation of detecting a user's puff action by a processor and outputting a notification to a user will be described with reference to FIGS. 5 to 6.

FIG. 5 is a flowchart illustrating a process of detecting a user's puff action of an aerosol generating device according to an embodiment. Hereinafter, a process of detecting the user's puff action of the aerosol generating device illustrated in FIG. 5 will be described with reference to components of the aerosol generating device 10 illustrated in FIGS. 2 and/or 3.

Referring to FIG. 5, in step 501, the aerosol generating device 10 (for example, the aerosol generating device 10 of FIGS. 2 and 3) according to an embodiment may detect a pressure change or a temperature change in an airflow passage 300 (for example, the airflow passage 300 of FIGS. 2 and 3) through a sensor 400 (for example, the sensor 400 of FIGS. 2 and 3).

In this case, information on the temperature change or the pressure change in the airflow passage 300 which is detected by the sensor 400 may be transmitted to a processor 410 (for example, the processor 410 of FIG. 2) electrically or operatively connected to the sensor 400.

In step 502, the processor 410 of the aerosol generating device 10 according to an embodiment may compare a pressure change amount or the temperature change amount of the airflow passage 300 which is detected in step 501 with a designated value in order to detect a user's puff action. In the present disclosure, the ‘designated value’ may refer to a temperature change amount value or a pressure change amount value of the airflow passage 300 which is a reference for detecting a user's puff action. For example, when the user's puff action occurs, a temperature change amount or a pressure change amount of the airflow passage 300 may be greater than or equal to a designated value. In addition, the designated value may be a value stored in the processor 410 or a memory (not illustrated), and the designated value may be changed by a type and a use environment of the aerosol generating device 10, or by a user's operation.

When a user's puff action occurs, a pressure drop or a temperature drop of the airflow passage 300 may occur while air of the airflow passage 300 is discharged to the outside of the aerosol generating device 10. Accordingly, the processor 410 may determine whether a pressure change amount or a temperature change amount of the airflow passage 300 detected by the sensor 400 is greater than or equal to a designated value in order to detect the user's puff action.

In one example, the processor 410 may determine whether a pressure drop amount of the airflow passage 300 is greater than or equal to a first designated value.

In another example, the processor 410 may determine whether a temperature drop amount of the airflow passage 300 is greater than or equal to a second designated value in order to detect a user's puff action. In this case, the second designated value serving as a reference for the temperature drop amount may be different from the first designated value serving as a reference for the pressure drop amount, but the first designated value may be equal to the second designated value depending on embodiments.

In step 503, when it is determined in step 502 that a pressure change amount or a temperature change amount of the airflow passage 300 is greater than or equal to a designated value, the processor 410 of the aerosol generating device 10 according to an embodiment may determine that there is occurrence of a user's puff action and output a notification indicating that there is occurrence of the user's puff action.

In one example, the processor 410 may output a visual notification indicating that there is occurrence of a user's puff action through a display (for example, the display D of FIG. 1) or an LED but is not limited thereto. In another example, the processor 410 may output an audible notification indicating that there is occurrence of the user's puff action through a speaker or a tactile notification indicating that there is occurrence of the user's puff action by generating vibration through a motor.

In addition, the processor 410 of the aerosol generating device 10 according to an embodiment may calculate the remaining number of puffs of the aerosol generating article 20 based on the detected number of puffs of a user and may also output a notification indicating the remaining number of puffs to the user.

According to one embodiment, when it is determined that there is occurrence of the user's puff action, the processor 410 may count the number of puffs of a user and calculate the remaining number of puffs of the aerosol generating article 20 based on a difference between the preset total number of puffs of the aerosol generating article 20 and the counted number of puffs of the user. For example, when the preset total number of puffs of the aerosol generating article 20 is 14 and the counted number of puffs of a user is 6, the processor 410 may set the remaining number of puffs of the aerosol generating article 20 to 8 and output a notification corresponding to the remaining number of puffs.

On the other hand, when it is determined in step 502 that the pressure change amount or the temperature change amount of the airflow passage 300 is less than a designated value, the aerosol generating device 10 according to an embodiment may determines that a pressure change or a temperature change is detected due to noise of the sensor 400 or there is no pressure change or temperature change and may perform step 501 and step 502 again.

FIG. 6 is a flowchart illustrating a process of detecting a user's puff action of an aerosol generating device according to another embodiment. Hereinafter, a process of detecting a user's puff action of the aerosol generating device illustrated in FIG. 6 will be described with reference to components of the aerosol generating device 10 illustrated in FIG. 2 and/or FIG. 3.

Referring to FIG. 6, in step 601, an aerosol generating device 10 (for example, the aerosol generating device 10 of FIGS. 2 and 3) may detect a pressure change or a temperature change in an airflow passage 300 (for example, the airflow passage 300 of FIGS. 2 and 3) through a sensor 400 (for example, the sensor 400 of FIGS. 2 and 3).

In step 602, a processor 410 (for example, the processor 410 of FIG. 2) of the aerosol generating device 10 may determine whether a pressure change amount or a temperature change amount of the airflow passage 300 which is detected by the sensor 400 in step 601 is greater than or equal to a designated value. Step 602 may be substantially the same as or similar to step 502 of FIG. 5, and redundant descriptions thereof are omitted.

In step 603, when it is determined in step 602 that the pressure change amount or the temperature change amount of the airflow passage 300 is greater than or equal to a designated value, the processor 410 of the aerosol generating device 10 may determine whether a designated time has elapsed after the heater 210 started to operate.

Meanwhile, when it is determined in step 602 that the pressure change amount or the temperature change amount of the airflow passage 300 is less than a designated value, the aerosol generating device 10 may determine that a pressure change or a temperature change is falsely detected due to noise of the sensor 400 or there is no pressure change or temperature change, and may perform step 601 and step 602 again.

After the heater 210 starts to operate, a preheating process for increasing a temperature of the heater 210 to a certain temperature for heating the aerosol generating article 20 may be performed during a designated time. In the present disclosure, the ‘designated time’ may indicate a time period from a start of the operation of the heater 210 to an end of the preheating process, and the expression may be used in the same meaning hereinafter.

In the preheating process, a pressure or a temperature of the airflow passage 300 may change due to heat generated by the heater 210. In this case, a pressure change or a temperature change in the airflow passage 300 which occurs during the preheating process of the heater 210 may be mistaken for a pressure change or a temperature change in the airflow passage 300 due to a user's puff action.

The aerosol generating device 10 according to an embodiment may determine whether a designated time has elapsed from the start of operation of the heater 210, when a pressure change amount or a temperature change amount of the airflow passage 300 becomes greater than or equal to a designated value. In this way, it is possible to prevent a pressure change or a temperature change in the airflow passage 300 which occurs during the preheating process from being mistaken for a pressure change or a temperature change in the airflow passage 300 due to a user's puff action.

In step 604, if it is determined that the pressure change amount or the temperature change amount of the airflow passage 300 became greater than or equal to the designated value after the designated time has elapsed from a start of operation of the heater 210, the processor 410 of the aerosol generating device 10 may determine that a pressure change or a temperature change in the airflow passage 300 is made by a user's puff action, and may output a notification indicating that there is occurrence of a users puff action. Step 604 may be substantially the same as or similar to step 503 of FIG. 5, and redundant descriptions thereof are omitted below.

In step 605, when it is determined that the pressure change amount or the temperature change amount of the airflow passage 300 became greater than or equal to the designated value before the designated time has elapsed from when the heater 210 started to operate, the processor 410 of the aerosol generating device 10 may determine that a pressure change or a temperature change in the airflow passage 300 is made by an operation of the heater 210, and may ignore the pressure change or the temperature change of the airflow passage 300.

In this way, the aerosol generating device 10 according to an embodiment may not mistake a pressure change or a temperature change in the airflow passage 300 caused by a preheating operation of the heater 210 for a pressure change or a temperature change in the airflow passage 300 due to a users puff action through step 601 to step 605. As a result, detection accuracy of a user's puff action may be improved.

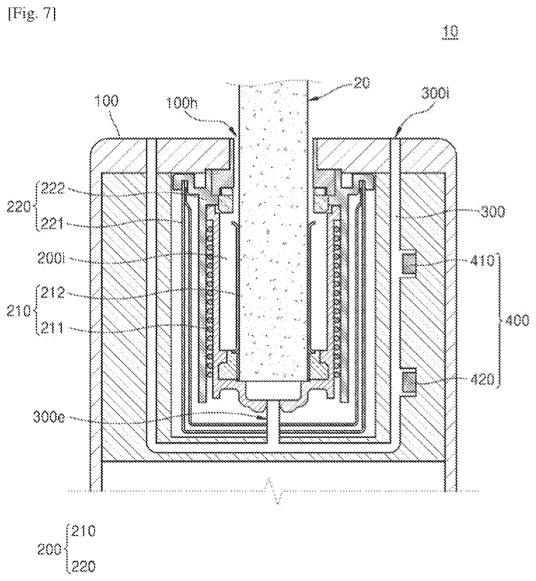

FIG. 7 is an enlarged cross-sectional view illustrating some components of an aerosol generating device according to another embodiment.

Referring to FIG. 7, an aerosol generating device 10 according to another embodiment may include a housing 100, a heater assembly 200, an airflow passage 300, and a sensor 400. The aerosol generating device 10 according to another embodiment may be a device in which the sensor 400 is changed from the sensor of the aerosol generating device 10 illustrated in FIG. 3, and redundant descriptions thereof are omitted below.

The sensor 400 may be arranged adjacent to the airflow passage 300 to detect a temperature change and a pressure change in the airflow passage 300.

According to one embodiment, the sensor 400 may include a pressure sensor 401 for detecting a pressure change in the airflow passage 300 and a temperature sensor 402 for detecting a temperature change in the airflow passage 300.

The pressure sensor 401 may be located at a first passage that branches off from the airflow passage 300 in a direction away from the heater assembly 200 and may detect a pressure change of the airflow passage 300 according to a user's puff action.

The temperature sensor 402 may be located at a second passage that branches off from the airflow passage 300 in a direction away from the heater assembly 200 and is separated from the first passage. The temperature sensor 402 may detect a temperature change of the airflow passage 300 according to a user's puff action. However, an arrangement structure of the pressure sensor 401 and the temperature sensor 402 illustrated in the drawing is an embodiment of the present disclosure, and the arrangement structure of the pressure sensor 401 and the temperature sensor 402 is not limited to the illustrated embodiment.

Each of the pressure sensor 401 and the temperature sensor 402 may be electrically or operatively connected to a processor (for example, the processor 410 of FIG. 2), and information on a pressure change amount and a temperature change amount of the airflow passage 300 detected by the pressure sensor 401 and the temperature sensor 402 may be transmitted to the processor.

The processor may detect occurrence of a user's puff action based on the information on the pressure change amount and the temperature change amount of the airflow passage 300 received from the pressure sensor 401 and the temperature sensor 402 and may output a notification indicating that there is occurrence of the user's puff action.

For example, when the pressure change amount of the airflow passage 300 is greater than or equal to a first designated value and the temperature change amount of the airflow passage 300 is greater than or equal to a second designated value, the processor may determine that there is occurrence of the user's puff action and may output a notification indicating that there is occurrence of the user's puff action.

For example, the notification may include a visual notification indicating that there is occurrence of a user's puff action through visual information, an audible notification indicating that there is occurrence of the user's puff action through audible information (for example, sound), and a tactile notification indicating that there is occurrence of the user's puff action through tactile information (for example, vibration), but is not limited thereto.

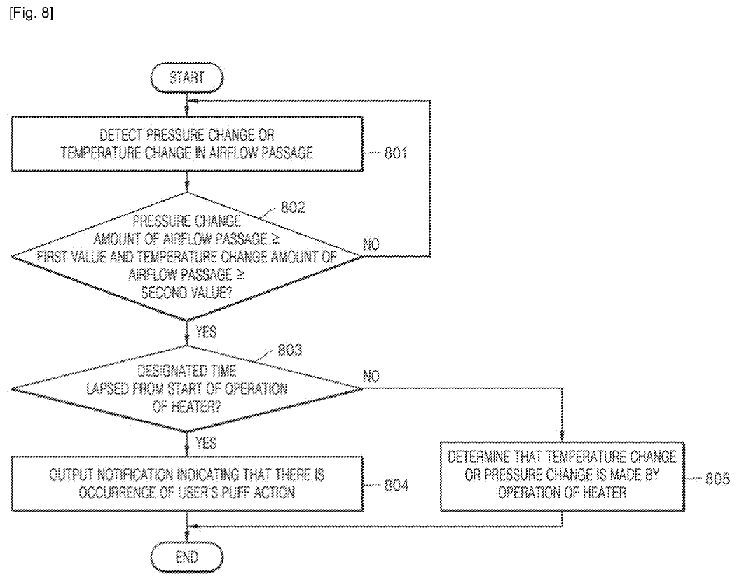

Hereinafter, the processor's operation of detecting a user's puff action and outputting, to a user, a notification indicating that there is occurrence of the user's puff action will be described in detail with reference to FIG. 8.

FIG. 8 is a flowchart illustrating a process of detecting a user's puff action by the aerosol generating device illustrated in FIG. 7. Hereinafter, the process of detecting the user's puff action by the aerosol generating device illustrated in FIG. 8 will be described with reference to components of the aerosol generating device 10 illustrated in FIG. 2 and/or FIG. 7.

Referring to FIG. 8, in step 801, an aerosol generating device 10 (for example, the aerosol generating device 10 of FIGS. 2 and 7) may detect a pressure change and a temperature change in the airflow passage 300 through a sensor 401 (for example, the pressure sensor 401 of FIG. 7) and a temperature sensor 402 (for example, the temperature sensor 402 of FIG. 7).

In step 802, a processor 410 (for example, the processor 410 of FIG. 2) of the aerosol generating device 10 may determine whether a pressure change amount and a temperature change amount of the airflow passage 300 are greater than or equal to designated values in order to detect a user's puff action.

When a user's puff action occurs, a pressure drop or a temperature drop of the airflow passage 300 may occur while air of the airflow passage 300 is discharged to the outside of the aerosol generating device 10. Accordingly, the processor 410 may determine whether a pressure change amount of the airflow passage 300 which is detected by the pressure sensor 401 is greater than or equal to a first designated value and whether a temperature change amount of the airflow passage 300 which is detected by the temperature sensor 402 is greater than or equal to a second designated value.

The ‘first designated value’ may refer to a pressure change amount of the airflow passage 300 which is a reference for detecting a user's puff action. When the user's puff action occurs, the pressure change amount of the airflow passage 300 may become greater than or equal to the first designated value. In addition, the ‘second designated value’ may refer to a temperature change amount of the airflow passage 300 which is a reference for detecting a user's puff action. When the user's puff action occurs, the temperature change amount of the airflow passage 300 may become greater than or equal to the second designated value.

In step 803, when it is determined that the pressure change amount of the airflow passage 300 is greater than or equal to the first designated value and the temperature change amount of the airflow passage 300 is greater than or equal to the second designated value, the processor 410 of the aerosol generating device 10 may determine whether a designated time has elapsed from a start of operation of the heater 210.

After the heater 210 starts to operate, a preheating process for increasing a temperature of the heater 210 to a certain temperature for heating the aerosol generating article 20 may be performed during a designated time. In the preheating process, a pressure or a temperature of the airflow passage 300 may change due to heat generated by the heater 210. In this case, a pressure change or a temperature change in the airflow passage 300 which occurs during the preheating process of the heater 210 may be mistaken for a pressure change or a temperature change in the airflow passage 300 due to a user's puff action.

The aerosol generating device 10 according to an embodiment may determine whether a designated time has elapsed from the start of operation of the heater 210, when a pressure change amount of the airflow passage 300 becomes greater than or equal to the first designated value and a temperature change amount becomes greater than or equal to the second designated value. In this way, it is possible to prevent a pressure change or a temperature change in the airflow passage 300 which occurs during the preheating process from being mistaken for a pressure change or a temperature change in the airflow passage 300 due to a user's puff action.

On the other hand, when it is determined in step 802 that the pressure change amount of the airflow passage 300 is less than the first designated value or the temperature change amount of the airflow passage 300 is less than the second designated value, the aerosol generating device 10 may determine that a pressure change or a temperature change is caused by noise of the sensor 400 or there is no pressure change or temperature change. Thus, the aerosol generating device 10 may repeat step 801 and step 802.

In step 804, if it is determined that the pressure change amount of the airflow passage 300 became greater than or equal to the first designated value and the temperature change amount of the airflow passage 300 became greater than or equal to the second designated value after the designated time has elapsed from a start of the operation of the heater 210, the processor 410 of the aerosol generating device 10 may determine that a pressure change or a temperature change in the airflow passage 300 is made by a user's puff action and may output a notification indicating that there is occurrence of a user's puff action.

In one example, the processor 410 may output a visual notification indicating that there is occurrence of a user's puff action through a display (for example, the display D of FIG. 1) or an LED but is not limited thereto. In another example, the processor 410 may output an audible notification indicating that there is occurrence of the user's puff action through a speaker or a tactile notification indicating that there is occurrence of the user's puff action by generating vibration through a motor.

In addition, the processor 410 of the aerosol generating device 10 according to another embodiment may calculate the remaining number of puffs of the aerosol generating article 20 based on the detected number of puffs of a user and may also output a notification indicating the remaining number of puffs to the user.

According to one embodiment, when it is determined that there is occurrence of the user's puff action, the processor 410 may count the number of puffs of a user, calculate the remaining number of puffs of the aerosol generating article 20 based on a difference between the preset total number of puffs of the aerosol generating article 20 and the counted number of puffs of the user, and output a notification to the user.

In step 805, when it is determined that the pressure change amount of the airflow passage 300 became greater than or equal to the first designated value and the temperature change amount of the airflow passage 300 became greater than or equal to the second designated value before the designated time has elapsed from the start of operation of the heater 210, the processor 410 of the aerosol generating device 10 may determine that a pressure change or a temperature change in the airflow passage 300 is made by an operation of the heater 210, and may ignore the pressure change or the temperature change of the airflow passage 300.

In this way, the aerosol generating device 10 according to an embodiment may not mistake a pressure change or a temperature change in the airflow passage 300 caused by a preheating operation of the heater 210 for a pressure change or a temperature change in the airflow passage 300 due to a user's puff action through step 801 to step 805. As a result, the aerosol generating device 10 may more precisely detect a user's puff action and provide a user with accurate puff information.

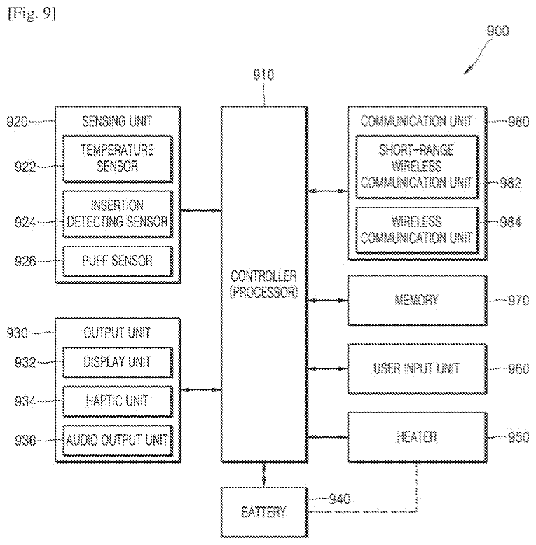

FIG. 9 is a block diagram of an aerosol generating device according to another embodiment.

An aerosol generating device 900 may include a controller 910 (or processor), a sensing unit 920, an output unit 930, a battery 940, a heater 950, a user input unit 960, a memory 970, and a communication unit 980. However, the internal structure of the aerosol generating device 900 is not limited to those illustrated in FIG. 9. That is, according to the design of the aerosol generating device 900, it will be understood by one of ordinary skill in the art that some of the components shown in FIG. 9 may be omitted or new components may be added.

The sensing unit 920 may sense a state of the aerosol generating device 900 and a state around the aerosol generating device 900, and transmit sensed information to the controller 910. Based on the sensed information, the controller 910 may control the aerosol generating device 900 to perform various functions, such as controlling an operation of the heater 950, limiting smoking, determining whether an aerosol generating article (e.g., a cigarette, a cartridge, or the like) is inserted, displaying a notification, or the like.

The sensing unit 920 may include at least one of a temperature sensor 922, an insertion detection sensor 924, and a puff sensor 926, but is not limited thereto.

The temperature sensor 922 may sense a temperature at which the heater 950 (or an aerosol generating material) is heated. The aerosol generating device 900 may include a separate temperature sensor for sensing the temperature of the heater 950, or the heater 950 may serve as a temperature sensor. Alternatively, the temperature sensor 922 may also be arranged around the battery 940 to monitor the temperature of the battery 940.

The insertion detection sensor 924 may sense insertion and/or removal of an aerosol generating article. For example, the insertion detection sensor 924 may include at least one of a film sensor, a pressure sensor, an optical sensor, a resistive sensor, a capacitive sensor, an inductive sensor, and an infrared sensor, and may sense a signal change according to the insertion and/or removal of an aerosol generating article.

The puff sensor 926 may sense a user's puff on the basis of various physical changes in an airflow passage or an airflow channel. For example, the puff sensor 926 may sense a user's puff on the basis of any one of a temperature change, a flow change, a voltage change, and a pressure change.

The sensing unit 920 may further include, in addition to the temperature sensor 922, the insertion detection sensor 924, and the puff sensor 926 described above, at least one of a temperature/humidity sensor, a barometric pressure sensor, a magnetic sensor, an acceleration sensor, a gyroscope sensor, a location sensor (e.g., a global positioning system (GPS)), a proximity sensor, and a red-green-blue (RGB) sensor (illuminance sensor). Because a function of each of sensors may be intuitively inferred by one of ordinary skill in the art from the name of the sensor, a detailed description thereof may be omitted.

The output unit 930 may output information on a state of the aerosol generating device 900 and provide the information to a user. The output unit 930 may include at least one of a display unit 932, a haptic unit 934, and a sound output unit 936, but is not limited thereto. When the display unit 932 and a touch pad form a layered structure to form a touch screen, the display unit 932 may also be used as an input device in addition to an output device.

The display unit 932 may visually provide information about the aerosol generating device 900 to the user. For example, information about the aerosol generating device 900 may mean various pieces of information, such as a charging/discharging state of the battery 940 of the aerosol generating device 900, a preheating state of the heater 950, an insertion/removal state of an aerosol generating article, or a state in which the use of the aerosol generating device 900 is restricted (e.g., sensing of an abnormal object), or the like, and the display unit 932 may output the information to the outside. The display unit 932 may be, for example, a liquid crystal display panel (LCD), an organic light-emitting diode (OLED) display panel, or the like. In addition, the display unit 932 may be in the form of a light-emitting diode (LED) light-emitting device.

The haptic unit 934 may tactilely provide information about the aerosol generating device 900 to the user by converting an electrical signal into a mechanical stimulus or an electrical stimulus. For example, the haptic unit 934 may include a motor, a piezoelectric element, or an electrical stimulation device.

The sound output unit 936 may audibly provide information about the aerosol generating device 900 to the user. For example, the sound output unit 936 may convert an electrical signal into a sound signal and output the same to the outside.

The battery 940 may supply power used to operate the aerosol generating device 900. The battery 940 may supply power such that the heater 950 may be heated. In addition, the battery 940 may supply power required for operations of other components (e.g., the sensing unit 920, the output unit 930, the user input unit 960, the memory 970, and the communication unit 980) in the aerosol generating device 900. The battery 940 may be a rechargeable battery or a disposable battery. For example, the battery 940 may be a lithium polymer (LiPoly) battery, but is not limited thereto.

The heater 950 may receive power from the battery 940 to heat an aerosol generating material. Although not illustrated in FIG. 9, the aerosol generating device 900 may further include a power conversion circuit (e.g., a direct current (DC)/DC converter) that converts power of the battery 940 and supplies the same to the heater 950. In addition, when the aerosol generating device 900 generates aerosols in an induction heating method, the aerosol generating device 900 may further include a DC/alternating current (AC) converter that converts DC power of the battery 940 into AC power.

The controller 910, the sensing unit 920, the output unit 930, the user input unit 960, the memory 970, and the communication unit 980 may each receive power from the battery 940 to perform a function. Although not illustrated in FIG. 9, the aerosol generating device 900 may further include a power conversion circuit that converts power of the battery 940 to supply the power to respective components, for example, a low dropout (LDO) circuit, or a voltage regulator circuit.

In an embodiment, the heater 950 may include any suitable electrically resistive material. For example, the suitable electrically resistive material may be a metal or a metal alloy including titanium, zirconium, tantalum, platinum, nickel, cobalt, chromium, hafnium, niobium, molybdenum, tungsten, tin, gallium, manganese, iron, copper, stainless steel, nichrome, or the like, but is not limited thereto. In addition, the heater 950 may be implemented by a metal wire, a metal plate on which an electrically conductive track is arranged, a ceramic heating element, or the like, but is not limited thereto.

In another embodiment, the heater 950 may be a heater of an induction heating type. For example, the heater 950 may include a susceptor that heats an aerosol generating material by generating heat through a magnetic field applied by a coil.

The user input unit 960 may receive information input from the user or may output information to the user. For example, the user input unit 960 may include a key pad, a dome switch, a touch pad (a contact capacitive method, a pressure resistance film method, an infrared sensing method, a surface ultrasonic conduction method, an integral tension measurement method, a piezo effect method, or the like), a jog wheel, a jog switch, or the like, but is not limited thereto. In addition, although not illustrated in FIG. 9, the aerosol generating device 900 may further include a connection interface, such as a universal serial bus (USB) interface, and may be connected to other external devices through the connection interface, such as the USB interface, to transmit and receive information, or to charge the battery 940.

The memory 970 is a hardware component that stores various types of data processed in the aerosol generating device 900, and may store data processed and data to be processed by the controller 910. The memory 970 may include at least one type of storage medium from among a flash memory type, a hard disk type, a multimedia card micro type memory, a card-type memory (for example, secure digital (SD) or extreme digital (XD) memory, etc.), random access memory (RAM), static random access memory (SRAM), read-only memory (ROM), electrically erasable programmable read-only memory (EEPROM), programmable read-only memory (PROM), a magnetic memory, a magnetic disk, and an optical disk. The memory 970 may store an operation time of the aerosol generating device 900, the maximum number of puffs, the current number of puffs, at least one temperature profile, data on a user's smoking pattern, etc.

The communication unit 980 may include at least one component for communication with another electronic device. For example, the communication unit 980 may include a short-range wireless communication unit 982 and a wireless communication unit 984.

The short-range wireless communication unit 982 may include a Bluetooth communication unit, a Bluetooth Low Energy (BLE) communication unit, a near field communication unit, a wireless LAN (WLAN) (Wi-Fi) communication unit, a Zigbee communication unit, an infrared data association (IrDA) communication unit, a Wi-Fi Direct (WFD) communication unit, an ultra wideband (UWB) communication unit, an Ant+ communication unit, or the like, but is not limited thereto.

The wireless communication unit 984 may include a cellular network communication unit, an Internet communication unit, a computer network (e.g., local area network (LAN) or wide area network (WAN)) communication unit, or the like, but is not limited thereto. The wireless communication unit 984 may also identify and authenticate the aerosol generating device 900 within a communication network by using subscriber information (e.g., International Mobile Subscriber Identifier (IMSI)).

The controller 910 may control the overall operation of the aerosol generating device 900. In an embodiment, the controller 910 may include at least one processor. The processor may be implemented as an array of a plurality of logic gates, or may be implemented as a combination of a general-purpose microprocessor and a memory in which a program executable by the microprocessor is stored. It will be understood by one of ordinary skill in the art that the processor may be implemented in other forms of hardware.

The controller 910 may control the temperature of the heater 950 by controlling supply of power of the battery 940 to the heater 950. For example, the controller 910 may control power supply by controlling switching of a switching element between the battery 940 and the heater 950. In another embodiment, a direct heating circuit may also control power supply to the heater 950 according to a control command of the controller 910.

The controller 910 may analyze a result sensed by the sensing unit 920 and control subsequent processes to be performed. For example, the controller 910 may control power supplied to the heater 950 to start or end an operation of the heater 950 on the basis of a result sensed by the sensing unit 920. In another embodiment, the controller 910 may control, based on a result sensed by the sensing unit 920, an amount of power supplied to the heater 950 and the time the power is supplied, such that the heater 950 may be heated to a certain temperature or maintained at an appropriate temperature.

The controller 910 may control the output unit 930 on the basis of a result sensed by the sensing unit 920. For example, when the number of puffs counted through the puff sensor 926 reaches a preset number, the controller 910 may notify the user that the aerosol generating device 900 will soon be terminated through at least one of the display unit 932, the haptic unit 934, and the sound output unit 936.

In an embodiment, the controller 910 may control the time of power supply and/or amount of power supply to the heater 950 according to a state of an aerosol generating article (e.g., the aerosol generating article 20 of FIG. 1) sensed by the sensing unit 920. For example, when the aerosol generating article 20 is in an over-wet state, the controller 910 may control the time of power supply to an induction coil (e.g., a coil 211 of FIG. 3) to increase the pre-heating time of the aerosol generating article 20 compared to a general condition.

One embodiment may also be implemented in the form of a computer-readable recording medium including instructions executable by a computer, such as a program module executable by the computer. The computer-readable recording medium may be any available medium that may be accessed by a computer, and includes both volatile and nonvolatile media, and removable and non-removable media. In addition, the computer-readable recording medium may include both a computer storage medium and a communication medium. The computer storage medium includes all of volatile and nonvolatile media, and removable and non-removable media implemented by any method or technology for storage of information such as computer-readable instructions, data structures, program modules, or other data. The communication medium typically includes computer-readable instructions, data structures, other data in modulated data signals such as program modules, or other transmission mechanisms, and includes any information transfer media.

The descriptions of the above-described embodiments are merely examples, and it will be understood by one of ordinary skill in the art that various changes and equivalents thereof may be made. Therefore, the scope of the disclosure should be defined by the appended claims, and all differences within the scope equivalent to those described in the claims will be construed as being included in the scope of protection defined by the claims.

1. An aerosol generating device comprising:
a housing including an opening for receiving an aerosol generating article;
a heater assembly located inside the housing and comprising an accommodation space for accommodating the aerosol generating article that is inserted through the opening;
an airflow passage located between the housing and the heater assembly to allow an outside of the aerosol generating device to fluid-communicate with an inside of the accommodation space;
a sensor arranged adjacent to the airflow passage and configured to detect at least one of a pressure change and a temperature change in the airflow passage; and
a processor electrically connected to the sensor and configured to output a notification of a user's puff action based on the at least one of the pressure change and the temperature change of the airflow passage.

2. The aerosol generating device of claim 1, wherein
the airflow passage is arranged to connect an air inlet formed in the housing to an air outlet formed in the accommodation space, such that air outside the aerosol generating device is introduced into the airflow passage through an air inlet, moves through the airflow passage, and flows into the accommodation space through the air outlet.

3. The aerosol generating device of claim 1, wherein the airflow passage is separated from the accommodation space by a designated distance.

4. The aerosol generating device of claim 1, wherein the heater assembly comprises a heater configured to heat the aerosol generating article that is inserted into the accommodation space to generate an aerosol.

5. The aerosol generating device of claim 4, wherein the heater assembly further comprises a heat insulating structure arranged to surround an outer circumferential surface of the heater to seal the heater and configured to insulate heat generated by the heater.

6. The aerosol generating device of claim 4, wherein the heater comprises:
a coil configured to generate an alternating magnetic field; and
a susceptor configured to heat the aerosol generating article that is inserted into the accommodation space by generating heat in response to the alternating magnetic field generated by the coil.

7. The aerosol generating device of claim 4, wherein the processor is configured to determine that there is no occurrence of the user's puff action before a designated time elapses from a start of an operation of the heater, regardless of the pressure change and the temperature change.

8. The aerosol generating device of claim 1, wherein the processor is configured to output the notification of the user's puff action, when a pressure drop of the airflow passage is greater than or equal to a first designated value.

9. The aerosol generating device of claim 1, wherein the processor outputs the notification of the user's puff action, when a temperature drop of the airflow passage is greater than or equal to a second designated value.

10. The aerosol generating device of claim 1, wherein the sensor comprises:
a pressure sensor configured to detect the pressure change in the airflow passage; and
a temperature sensor separated from the pressure sensor and configured to detect the temperature change in the airflow passage.

11. The aerosol generating device of claim 10, wherein the processor is configured to output the notification of a user's puff action, when a pressure drop of the airflow passage is greater than or equal to a first designated value and a temperature drop of the airflow passage is greater than or equal to a second designated value.

12. The aerosol generating device of claim 1, further comprising:
a display,
wherein the processor is configured to control the display to display the notification of the user's puff action.

13. An operating method of an aerosol generating device, the operating method comprising:
detecting, by a sensor, at least one of a pressure change and a temperature change of an airflow passage that is formed between a housing including an opening into which an aerosol generating article is inserted and a heater assembly including an accommodation space for accommodating the aerosol generating article inserted through the opening, the airflow passage allowing an outside of the aerosol generating device to fluid-communicate with the accommodation space; and
outputting a notification of a user's puff action based on at least one of a pressure change and a temperature change of the airflow passage.

14. The operating method of claim 13, wherein, the outputting of the notification comprises outputting the notification of the user's puff action when a pressure drop of the airflow passage is greater than or equal to a first designated value.

15. The operating method of claim 13, wherein the outputting of the notification comprises outputting the notification of the user's puff action when a temperature drop of the airflow passage is greater than or equal to a second designated value.
